(19) United States
(12) Patent Application Publication
(10) Pub. No.: US 2023/0282831 A1
(43) Pub. Date: Sep. 7, 2023

(54) BINDER, ELECTRODE INCLUDING SAME BINDER, SECONDARY BATTERY INCLUDING SAME ELECTRODE, CAPACITOR INCLUDING SAME ELECTRODE, AND METHDO OF PREPARING BINDER

(71) Applicant: ECOCHEMICAL CO., LTD., Ulsan (KR)

(72) Inventors: Jin Seok SO, Siheung-si (KR); Tae Won KIM, Ulsan (KR); Bo Yeon KIM, Ulsan (KR); Ji Won LEE, Ulsan (KR)

(21) Appl. No.: 17/527,742

(22) Filed: Nov. 16, 2021

(30) Foreign Application Priority Data
Sep. 17, 2021 (KR) 10-2021-0124765
Sep. 17, 2021 (KR) 10-2021-0124766

(51) Int. Cl. H01M 4/62; C08L 25/06; H01G 11/48

(52) U.S. Cl. CPC H01M 4/622; C08L 25/06; H01G 11/48; C08L 2207/53; H01M 2004/027

(57) ABSTRACT

The present disclosure relates to a binder, an electrode including the same binder, a secondary battery including the same electrode, a capacitor including the same electrode, and a method of preparing a binder.

### CROSS-REFERENCE TO RELATED APPLICATIONS

The present application claims the priority to Korean Patent Application No. 10-2021-0124765 filed on Sep. 17, 2021, and Korean Patent Application No. 10-2021-0124766 filed on Sep. 17, 2021, the entire disclosures of which are hereby incorporated by reference.

### TECHNICAL FIELD

The present invention relates to a binder, an electrode including the same binder, a secondary battery including the same electrode, a capacitor including the same electrode, and a method of preparing the binder.

### BACKGROUND ART

As the demand for electric vehicles and mobile devices increases, secondary batteries are attracting attention as power sources for driving the electric vehicles and the mobile devices. Among secondary batteries, lithium secondary batteries are widely used due to the advantages of high energy density and voltage per weight and quick charging.

Similarly, electric double-layer capacitors using an electric double layer formed at an interface between a polarizable electrode and an electrolyte are used as large-capacity power storage devices such as a memory backup power source or an electric vehicle power source.

Lithium secondary batteries or electric double-layer capacitors include one or more electrodes having a structure in which an electrode active material is bound to a current collector by a binder. A separator, an electrolyte, etc. are disposed between the electrodes. Electricity is generated, stored, or consumed by oxidation-reduction reactions or physical bonding by ions or electrons at the interface between the electrode and the electrolyte.

Here, the binder binds to the electrode active material to the electrode and sometimes binds an additive such as a conductive material that is added to improve conductivity. The binder must maintain stable adhesive properties even in the chemical environment in which the binder comes into contact with the electrolyte and in the harsh electrochemical environment in which oxidation reduction reactions occur. In addition, in the case of medium-scale to large-scale batteries that are usually used for more than 10 years, the reliability of a polymer material used for a binder therefor needs to be secured.

Currently, organic-based binders such as polyvinylidene fluoride (PVdF), fluorine-based polymer binders such as polytetrafluoroethylene, and water-based binders such as styrene butadiene rubber (SBR) have been commercially used. However, it is still necessary to develop a binder with low electrical resistance while having binding force and mechanical properties to the extent that it can withstand volume changes such as volume expansion of an active material during charge and discharge of an electrochemical device.

### Documents of Related Art

### Patent Document

(Patent Document 0001) Korean Patent No. 10-0491026 (May 13, 2005)

### DISCLOSURE

### Technical Problem

The present invention relates to a binder with improved binding force to an electrode, an electrode including the same binder, a secondary battery including the same electrode, a capacitor including the same electrode, and a method of preparing the binder.

### Technical Solution

One embodiment of the present invention proposes a binder including a core and a shell, wherein the shell contains a copolymer including repeating units derived from a (meth)acrylic acid ester monomer, a nitrile group-containing monomer and a polar group-containing monomer, and

the content of the nitrile group-containing monomer is 0.1 to 45 parts by weight relative to 100 parts by weight of the (meth)acrylic acid ester monomer.

One embodiment of the present invention proposes an electrode including the binder and an electrode active material.

One embodiment of the present invention proposes a secondary battery including the electrode.

One embodiment of the present invention proposes a capacitor including the electrode.

One embodiment of the present invention proposes a method of preparing a binder, the method including: preparing a core including core polymer particles;

forming a shell on the surface of the core by mixing the core with a shell polymer solution containing a (meth)acrylic acid ester monomer, a nitrile group-containing monomer, a polar group-containing monomer, and an emulsifier.

### Advantageous Effects

The binder according to an exemplary embodiment of the present invention has the advantage of excellent binding force with respect to an electrode member.

When the binder according to an exemplary embodiment of the present invention is applied to an electrode, structural stability and battery performance can be improved.

The binder preparation method according to an exemplary embodiment of the present invention has the advantage of manufacturing a binder having excellent binding force with respect to an electrode member.

### BEST MODE

Hereinafter, embodiments of the present invention will be described in detail.

During charging and discharging of a battery, volume expansion usually occurs, resulting in stress to the battery. The stress cause cracks in an electrode, and irreversibility occurs on the surface of the cracks. When the bonding force of the electrode is weak, the electrode is likely to be detached from a current collector during charging and discharging of the battery. As a result, cycle characteristics may be deteriorated with the repeat of charge and discharge cycles.

The binder according to an exemplary embodiment of the present invention has an improved binding force or has the advantage of improving a binding force with respect to an electrode, thereby preventing the detachment of the electrode.

Specifically, one embodiment of the present invention proposes a binder including a core and a shell, in which the shell contains a copolymer including repeating units derived from a (meth)acrylic acid ester monomer, a nitrile group-containing monomer and a polar group-containing monomer, and

the content of the nitrile group-containing monomer is 0.1 to 45 parts by weight relative to 100 parts by weight of the (meth)acrylic acid ester monomer.

The shell may contain a copolymer prepared by copolymerizing a (meth)acrylic acid ester monomer, a nitrile group-containing monomer, and a polar group-containing monomer, and may contain repeating units derived from each of the monomers.

The inventors of the present application have found that the binding force to the electrode member can be improved when the content of the nitrile group-containing monomer is adjusted to be 0.1 to 45 parts by weight relative to 100 parts by weight of the (meth)acrylic acid ester monomer, and have devised the present invention on the basis of the finding.

The (meth)acrylic acid ester monomer is relatively soft due to a low glass transition temperature (Tg), whereas the nitrile group-containing monomer is relatively hard due to a high glass transition temperature (Tg). By adjusting the hardness and the softness, it is possible to prevent the adhesiveness from being lowered.

In an exemplary embodiment of the present invention, the content of the nitrile group-containing monomer is adjusted to 0.5 to 40 parts by weight, preferably 1 to 35 parts by weight, and more preferably 11 to 30 parts by weight relative to 100 parts by weight of the (meth)acrylic acid ester monomer.

In an exemplary embodiment of the present invention, the (meth)acrylic acid ester monomer may contain a C1 to C6 alkyl group. The number of the C1 to C6 alkyl groups may be one or two. Specifically, the (meth)acrylic acid ester monomers may contain methyl acrylate, ethyl acrylate, propyl acrylate, isopropyl acrylate, butyl acrylate, isobutyl acrylate, 2-ethylhexyl acrylate or n-hexyl acrylate.

In an exemplary embodiment of the present invention, the (meth)acrylic acid ester monomer preferably includes butyl acrylate. Since the butyl acrylate has a low glass transition temperature (Tg) and a soft property due to a short chain length of the alkyl group, the butyl acrylate maintains a high binding force.

In an exemplary embodiment of the present invention, the nitrile group-containing monomer may be acrylonitrile, methacrylonitrile, cyanoalkyl acrylate, or a mixture thereof. Since the acrylonitrile has a high glass transition temperature (Tg) and has a hard property, the acrylonitrile has excellent tensile strength.

In an exemplary embodiment of the present invention, the cyanoalkyl acrylate refers to an acrylate substituted with an alkyl group and a cyano group, and the number of carbon atoms in the alkyl group is not particularly limited but may be 1 to 6 (i.e., C1 to C6 alkyl group).

In an exemplary embodiment of the present invention, the cyanoalkyl acrylate may be 2-cyanobutyl acrylate or 2-cyanoethyl acrylate.

In an exemplary embodiment of the present invention, a polar group may be introduced into the copolymer contained in the shell due to the polar group of the polar group-containing monomer, thereby improving the binding between the core and the shell.

In one embodiment of the present invention, the polar group may be at least one selected from the group consisting of a hydroxyl group, a carboxyl group, an amide group, an amino group, and a sulfonic acid group, and preferably the polar group may be a carboxyl group.

In an exemplary embodiment of the present invention, the polar group-containing monomer may be at least one selected from the group consisting of maleic acid, fumaric acid, methacrylic acid, acrylic acid, glutaconic acid, itaconic acid, tetrahydrophthalic acid, corotonic acid, isocrotonic acid, and nadic acid. Preferably, acrylic acid or itaconic acid may be used as the polar-group containing monomer.

In an exemplary embodiment of the present invention, the content of the polar group-containing monomer is in a range of 5 parts by weight or less, in a range of 0.1 to 4 parts by weight, or 0.1 to 4 parts by weight, relative to 100 parts by weight of the total weight of the (meth)acrylic acid ester monomer and the nitrile group-containing monomer. Preferably, the content of the polar group-containing monomer is in a range of 0.1 to 1 parts by weight relative to 100 parts by weight of the total weight of the (meth)acrylic acid ester monomer and the nitrile group-containing monomer. When the above content range is satisfied, the functional groups included in the shell are sufficient, so that the good binding force between the shell and the core can be maintained.

In an exemplary embodiment of the present invention, the core may contain a polymer including repeating units derived from a styrenic monomer.

In one embodiment of the present invention, aside from the styrenic monomer, the polymer of the core may include repeating units derived from at least one monomer selected from the group consisting of acrylate-based monomers, (meth)acrylic acid ester monomers, vinyl-based monomers, nitrile-based monomers, and unsaturated carboxylic acid monomers.

In one embodiment of the present invention, non-limiting examples of the acrylate-based monomer include methacryloxyethylethyleneurea, β-carboxyethyl acrylate, aliphatic monoacrylate, dipropylene diacrylate, ditrimethylopropane tetraacrylate, hydroxyethyl acrylate, dipentaerythriol hexaacrylate, pentaerythriol triacrylate, pentaerythriol tetraacrylate, lauryl acrylate, cetyl acrylate, stearyl acrylate, lauryl methacrylate, cetyl methacrylate, stearyl methacrylate, or a mixture thereof.

In an exemplary embodiment of the present invention, non-limiting examples of the (meth)acrylic acid ester monomer include methyl acrylate, ethyl acrylate, propyl acrylate, isopropyl acrylate, n-butyl acrylate, isobutyl acrylate, n-amyl acrylate, isoamyl acrylate, n-hexyl acrylate, 2-ethylhexyl acrylate, and the like, and non-limiting examples of the methacrylic acid ester-based monomer include methyl methacrylate, ethyl methacrylate, Propyl methacrylate, isopropyl methacrylate, n-butyl methacrylate, isobutyl methacrylate, n-amyl methacrylate, isoamyl methacrylate, n-hexyl methacrylate, 2-ethylhexyl methacrylate lactate, hydroxyethyl methacrylate, hydroxypropyl methacrylate, and mixtures thereof.

In one embodiment of the present invention, non-limiting examples of the vinyl-based monomer include styrene, α-methylstyrene, P-methylstyrene, p-t-butylstyrene, divinylbenzene, and mixtures thereof. Non-limiting examples of the conjugated diene-based monomer include 1,3-butadiene, isoprene, 2,3-dimethyl-1,3-butadiene, 1,3-pentadiene, or mixtures thereof. Non-limiting examples of the nitrile group-containing compound include acrylonitrile, methacrylonitrile, and mixtures thereof. Non-limiting examples of the (meth)acrylamide-based monomer include acrylamide, n-methylolacrylamide, n-butoxymethylacrylamide, methacrylamide, and mixtures thereof.

In an exemplary embodiment of the present invention, non-limiting examples of the unsaturated monocarboxylic acid-based monomer include acrylic acid, methacrylic acid, itaconic acid, maleic acid, fumaric acid, citraconic acid, methaconic acid, glutaconic acid, tetrahydrophthalic acid, crotonic acid, isocrotonic acid, nadic acid, and mixtures thereof.

In one embodiment of the present invention, the range of the weight ratio of the core and the shell is 10:1 to 1:10, 5:1 to 1:10, 1:1 to 1:10, 1:3 to 1 :10, or 1:6 to 1:10. When the above range is satisfied, the shell sufficiently surrounds the core so that the structural stability is improved.

One embodiment of the present invention proposes an electrode containing the binder and an electrode active material.

In one embodiment of the present invention, the electrode may further contain a conductive material.

In an exemplary embodiment of the present invention, the electrode may include an electrode slurry containing at least one selected from the binder, the electrode active material, and the conductive material.

In an exemplary embodiment of the present invention, the content of the binder may be in a range of 1 to 30 parts by weight relative to the total weight of the electrode slurry.

In an exemplary embodiment of the present invention, the electrode may be a positive electrode or a negative electrode.

In an exemplary embodiment of the present invention, the electrode may be a negative electrode.

In an exemplary embodiment of the present invention, the electrode may further contain activated carbon.

One embodiment of the present invention proposes a secondary battery including the electrode.

One embodiment of the present invention proposes a capacitor including the electrode.

In an exemplary embodiment of the present invention, aside from the secondary battery and the capacitor, the electrode may be used in a lithium ion secondary battery, a lithium metal secondary battery, a fuel cell, a solar cell, or a supercapacitor.

One embodiment of the present invention proposes a method of preparing the binder described above. The method includes: preparing the core containing core polymer particles; and forming the shell on the surface of the core by mixing the core with a shell polymer solution containing a (meth)acrylic acid ester monomer, a nitrile group-containing monomer, a polar group-containing monomer, and an emulsifier.

In an exemplary embodiment of the present invention, the shell polymer solution includes a (meth)acrylic acid ester monomer, a nitrile group-containing monomer, a polar group-containing monomer, and an emulsifier.

In an exemplary embodiment of the present invention, the emulsifier has both of a hydrophobic group and a hydrophilic group. When the emulsifier is dispersed in a solution, the hydrophilic group is dispersed in water that is a dispersion medium, and the hydrophobic group is dispersed in a monomer phase that is an organic phase. In this case, a space for polymerization of the monomer is provided by forming micelles, and the emulsifier molecules that do not form micelles surround the polymer particles resulting from the polymerization and prevent collisions between the particles, thereby preventing the particles from aggregating.

In an exemplary embodiment of the present invention, the content of the emulsifier is in a range of 0.1 to 10 parts by weight, or preferably 0.1 to 5 parts by weight, or most preferably 0.1 to 3 parts by weight relative to 100 parts by weight of the total weight of the (meth)acrylic acid ester monomer and the nitrile group-containing monomer. When the above numerical range is satisfied, emulsification limitation during binder manufacture is improved and the storage stability of the prepared binder is also improved.

In an exemplary embodiment of the present invention, as the emulsifier, one material selected from the following materials is solely used or a combination of two or more materials selected from the following materials are used: lauryl sulfates such as sodium lauryl sulfate (SLS), ammonium lauryl sulfate, and potassium lauryl sulfate; sulfates such as sodium dodecyl sulfate (SDS); nonionic emulsifiers such as polyoxyethylene nonylphenyl ether, polyoxyethylene sorbitan lauryl ester, and polyoxyethylene-polyoxypropylene block copolymer; gelatin, maleic anhydride-ethylene copolymer, and polyvinylpyrrolidone; benzenesulfonate sodium salt such as sodium dodecylbenzenesulfonate and sodium dodecylphenylethersulfonate; alkyl sulfate sodium salts such as sodium lauryl sulfate and sodium tetradodecyl sulfate; sodium sulfosuccinate salts such as sodium dioctylsulfosuccinate and sodium dihexylsulfosuccinate; and fatty acid sodium salts such as sodium laurate.

In an exemplary embodiment of the present invention, in the shell polymer solution, the content of a neutralizing agent is higher than the content of the polar group-containing monomer by 0.5 to 10 equivalents.

In an exemplary embodiment of the present invention, in the shell polymer solution, the content of the neutralizing agent is higher than the content of the polar group-containing monomer by 0.5 to 5 equivalents or 0.5 to 3 equivalents.

In one embodiment of the present invention, the neutralizing agent may be Na₂CO₃, NaHCO₃, or (NH₄)₂CO₃.

In an exemplary embodiment of the present invention, the pH of the binder may be adjusted to fall within a range of 4 to 8 Specifically, the binder may have a pH of 4 to 8.

### Mode for Invention

Hereinafter, the present invention will be described in detail with reference to examples.

### Comparative Example 1

A pre-emulsion solution was prepared by mixing 6 g (4 pt/M) of sodium lauryl sulfate (SLS) serving as an emulsifier and 150 g of a styrene monomer, in 100 g of distilled water. 40 vol% of the prepared pre-emulsion solution was added to a reactor in which 230 g of distilled water was contained, nitrogen purging was performed while the temperature of the reactor was raised to 75° C. When the reactor temperature reached 75° C., 40% of an initiator solution obtained by mixing 0.6 g (0.4 pt/M) of ammonium persulfate (APS) serving as an initiator with 20 g of distilled water was added, and the resulting solution mixture was stirred for 40 minutes. Next, the solution mixture of the pre-emulsion solution and the initiator solution remaining in the reactor was continuously fed for 2 hours by using a metering pump. The temperature of the reactor was raised to 85° C., the reaction was continuously performed for an additional hour, and the resulting product was cooled down to room temperature to terminate the reaction. As a result, a core solution containing a polystyrene polymer and having a total solid concentration (TSC) of 30% was prepared.

3.6 g (2 pt/M) of sodium lauryl sulfate (SLS) as an emulsifier, and 180 g of shell monomers including butyl acrylate (BA) 120 g and acrylonitrile (AN) 60 g were added to 120 g of distilled water 120 g, and stirred to prepare a pre-emulsion solution. 30 wt% of the prepared pre-emulsion solution, 66.67 g of the core solution (20 g of solid content), 113.33 g of distilled water, and 0.9 g (0.5 pt/M) of itaconic acid were mixed and put into a reactor. The inside of the reactor was purged with nitrogen gas. The temperature of the reactor was raised to 75° C. and stirred for 1 hour and 30 minutes.

0.9 g (0.5 pt/M) of ammonium persulfate (APS), which is an initiator, was added to the remaining pre-emulsion and mixed, and the mixed solution was continuously added for 2 hours and 30 minutes with the use of a metering pump. When the addition was finished, an initiator solution obtained by mixing 0.9 g of ammonium persulfate with 20 g of distilled water was added to the reactor. Next, the temperature of the reactor was raised to 85° C., the reaction was con”tinued for 1 hour, and the reactor was cooled down to room temperature so that the shell polymerization reaction was finished.

Thereafter, the pH of the polymer was adjusted to 7 using a 5 wt% aqueous NaHCO₃ solution to prepare a binder.

### Comparative Example 2

A binder was prepared in the same manner as in Comparative Example 1, except that acrylonitrile (AN) among the shell monomers was not used and the content of each monomer was changed as shown in Table 1 below.

### Examples 1 to 8

Binder were prepared in the same manner as in Comparative Example 1, except that the contents of butyl acrylate (BA), acrylonitrile (AN), and itaconic acid of the shell monomers were changed as shown in Table 1 below.

### Examples 9 to 11

Binder were prepared in the same manner as in Comparative Example 1, except that the content of sodium lauryl sulfate (SLS) in the core solution was changed to 3 g, and the contents of butyl acrylate (BA), acrylonitrile (AN) and itaconic acid of the shell monomers were changed as shown in Table 1 below.

### Method of Measuring Binding Force

An experiment was performed to measure the binding force between the composition for a negative electrode and a current collector when the binder according to each of the examples and comparative examples was used for the negative electrode. In order to prepare electrodes for measuring the binding force, the electrode composition prepared by mixing 1.4 wt% of one of the binders of the comparative examples and the examples, 97.6 wt% of a negative electrode active material, and 1 wt% of carboxymethyl cellulose (CMC) was applied at Loading level 7 (7 mg/cm²), then dried at 70° C. for 30 minutes, and then dried at 90° C. for 30 minutes in a vacuum state. After preparing electrode specimens by cutting the dried electrodes to have a width of 4 cm and pressing about 30% of the thickness of the electrode, double-sided tape with a width of 4.5 cm (manufactured by Haesung Corporation) was attached to a stainless steel substrate, the electrode specimen was attached to the tape such that a specimen surface with slurry visible faces up. Next, a tape adhesion apparatus (2 kgf rubber roller, KS T 1028) is used to increase a fixing force. That is, the tape was pressed at room temperature, using only the weight of the roller without external force, and the roller was reciprocated twice at a compression speed of 300 mm/min to fix an electrode plate and the stainless substrate. Next, only a current collector was bitten by a stainless steel jig, and the current collector was peeled off at a speed of 300 mm/min in 180° peel test mode. In the test, a texture analyzer (model name: TXA™-Precision) manufactured by Yeonjin S-Tech Corporation was used, and the standard load cell used was 1 kgf, and all peeling tests were performed under standard conditions (room temperature (RT) and normal pressure). The results of measuring the 180° peel strength using the test method are shown in Table 1 below. The peel strength of each of 5 samples was measured and the average value was obtained.

TABLE 1

| | Comparative Example 1 | Comparative Example 2 | Example 1 | Example 2 | Example 3 | Example 4 | Example 5 | Example 6 | Example 7 | Example 8 | Example 9 | Example 10 | Example 11 |
|---|---|---|---|---|---|---|---|---|---|---|---|---|---|
| BA content (g) | 120 | 180 | 135 | 144 | 145.8 | 150 | 162 | 150 | 150 | 150 | 150 | 150 | 150 |
| AN content (g) | 60 | 0 | 45 | 36 | 34.2 | 30 | 18 | 30 | 30 | 30 | 30 | 30 | 30 |
| SLS | 3.6 | 3.6 | 3.6 | 3.6 | 3.6 | 3.6 | 3.6 | 3.6 | 3.6 | 3.6 | 1.8 | 0.9 | 0.36 |
| IA | 0.9 | 0.9 | 0.9 | 0.9 | 0.9 | 0.9 | 0.9 | 1.8 | 2.88 | 5.4 | 0.9 | 0.9 | 0.9 |
| Binding Force(N /4cm) | 0.167 | 0.219 | 0.38 | 0.685 | 0.714 | 0.434 | 0.316 | 0.513 | 0.431 | 0.323 | 0.508 | 0.638 | 1.049 |
| AN/BA | 50 | 0 | 33.33 | 25 | 23.46 | 20 | 11.11 | 20 | 20 | 20 | 20 | 20 | 20 |
| IA/(AN +BA) | 0.5 | 0.5 | 0.5 | 0.5 | 0.5 | 0.5 | 0.5 | 1 | 1.6 | 3 | 0.5 | 0.5 | 0.5 |

Referring to the above results, when the shell contains an excessive amount of the nitrile group-containing monomer (Comparative Example 1) or does not contain the nitrile group-containing monomer (Comparative Example 2), it was confirmed that the binding force was significantly lowered.

On the other hand, when the content of the nitrile group-containing monomer was adjusted to 0.1 to 45 parts by weight relative to 100 parts by weight of the (meth)acrylic acid ester monomer (Examples 1 to 11), it was confirmed that the binding force was excellent.

1. A binder comprising a core and a shell, wherein the shell comprises a copolymer including repeating units derived from a (meth)acrylic acid ester monomer, a nitrile group-containing monomer, and a polar group-containing monomer, and
the nitrile group-containing monomer is contained in an amount of 0.1 to 45 parts by weight relative to 100 parts by weight of the (meth)acrylic acid ester monomer.

2. The binder according to claim 1, wherein the (meth)acrylic acid ester monomer comprises a C1 to C6 alkyl group.

3. The binder according to claim 1, wherein the (meth)acrylic acid ester monomer comprises butyl acrylate.

4. The binder according to claim 1, wherein the nitrile group-containing monomer comprises acrylonitrile, methacrylonitrile, cyanoalkyl acrylate, or a mixture thereof.

5. The binder according to claim 1, wherein the polar group-containing monomer is contained in an amount of 5 parts by weight or less relative to 100 parts by weight of the sum of the (meth)acrylic acid ester monomer and the nitrile group-containing monomer.

6. The binder according to claim 1, wherein the polar group is at least one selected from the group consisting of a hydroxyl group, a carboxy group, an amide group, an amino group, and a sulfonic acid group.

7. The binder according to claim 1, wherein the polar group-containing monomer comprises at least one selected from the group consisting of maleic acid, fumaric acid, methacrylic acid, acrylic acid, glutaconic acid, itaconic acid, tetrahydrophthalic acid, corotonic acid, isocrotonic acid, and nadic acid.

8. The binder according to claim 1, wherein the core comprises a polymer including repeating units derived from a styrenic monomer.

9. The binder according to claim 1, wherein the weight ratio of the core and the shell is in a range of 10:1 to 1:10.

10. An electrode comprising the binder according to claim 1 and an electrode active material.

11. The electrode according to claim 10, wherein the electrode is a negative electrode.

12. A secondary battery comprising the electrode according to claim 10.

13. A capacitor comprising the electrode according to claim 10.

14. A method of preparing the binder according to claim 1, the method comprising:
preparing a core comprising core polymer particles; and
forming a shell on the surface of the core by mixing the core with a shell polymer solution containing a (meth)acrylic acid ester monomer, a nitrile group-containing monomer, a polar group-containing monomer, and an emulsifier.

15. The method according to claim 14, wherein the emulsifier is contained in an amount of 0.1 to 10 parts by weight relative to 100 parts by weight of the sum of the (meth)acrylic acid ester monomer and the nitrile group-containing monomer.
